(19) United States
(12) Patent Application Publication
(10) Pub. No.: US 2025/0231534 A1
(43) Pub. Date: Jul. 17, 2025

(54) INFORMATION PROCESSING METHOD, INFORMATION PROCESSING APPARATUS, AND PROGRAM FOR CREATING CONTROL CONTENT OF APPLIANCE

(71) Applicant: Panasonic Intellectual Property Corporation of America, Torrance, CA (US)

(72) Inventors: Takuya YAMAGUCHI, Osaka (JP); Kenta MURAKAMI, Osaka (JP); Masashi OTANI, Osaka (JP)

(73) Assignee: Panasonic Intellectual Property Corporation of America, Torrance, CA (US)

(21) Appl. No.: 19/098,735

(22) Filed: Apr. 2, 2025

Related U.S. Application Data
(63) Continuation of application No. PCT/JP2023/033503, filed on Sep. 14, 2023.

(30) Foreign Application Priority Data
Oct. 5, 2022 (JP) 2022-160944

(51) Int. Cl. G05B 13/04

(52) U.S. Cl. CPC G05B 13/04

(57) ABSTRACT

A receiver receives a target temperature curve. A processor converts the received target temperature curve into a block sequence. At that time, the processor creates the block sequence while changing arrangement of blocks and at least one of parameters of the blocks, acquires, as an estimated temperature curve, a temperature curve in a case where an appliance is caused to execute the created block sequence, and searches for the block sequence in which the estimated temperature curve approaches the target temperature curve. An outputter outputs the converted block sequence.

This application is based upon and claims the benefit of priority from the prior Japanese Patent Application No. 2022-160944, filed on Oct. 5, 2022, the entire contents of which are incorporated herein by reference.

### BACKGROUND

### 1. Technical Field

The present disclosure relates to information processing technology, and particularly, to an information processing method, an information processing apparatus, and a program for creating control content of an appliance.

### 2. Description of the Related Art

If the user performs cooking while manipulating a cooking machine, the cooking machine transmits cooking control information corresponding to content of the manipulation to a home terminal.

The home terminal creates a cooking procedure by associating the received cooking control information with elapsed time of the cooking (see, for example, JP 2006-329455 A).

In JP 2006-329455 A, cooking by a user is performed to create a cooking procedure. In order to make cooking by the user unnecessary, for example, a plurality of types of manipulations that can be executed in a cooking machine are arranged in time series, and the cooking procedure is created by adjusting parameters of each of the manipulations. However, the creation of such cooking procedure is not intuitive for the user.

### SUMMARY

The present disclosure has been made in view of such a situation, and an object of the present disclosure is to provide a technique for intuitively creating a cooking procedure by a user.

In order to solve the above problem, an information processing method according to one aspect of the present disclosure includes: a step of receiving, as a target temperature curve, a temperature curve that indicates a temperature change of an appliance over time and that is a target; a step of converting the received target temperature curve into a block sequence in which blocks defined in a functional unit executable by the appliance are arranged in an order of operation; and a step of outputting the converted block sequence. In the conversion step, the block sequence is created while arrangement of the blocks and at least one of parameters of the blocks are changed, a temperature curve in a case where the appliance is caused to execute the created block sequence is acquired as an estimated temperature curve, and the block sequence in which the estimated temperature curve approaches the target temperature curve is searched for.

Another aspect of the present disclosure is an information processing apparatus. The apparatus includes: a receiver structured to receive, as a target temperature curve, a temperature curve that indicates a temperature change of an appliance over time and that is a target; a processor structured to convert the received target temperature curve into a block sequence in which blocks defined in a functional unit executable by the appliance are arranged in an order of operation; and an outputter structured to output the converted block sequence. The processor creates the block sequence while changing arrangement of the blocks and at least one of parameters of the blocks, acquires, as an estimated temperature curve, a temperature curve in a case where the appliance is caused to execute the created block sequence, and searches for the block sequence in which the estimated temperature curve approaches the target temperature curve.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

FIGS. 1A to 1G show configurations of an appliance control system according to the present embodiment;

FIGS. 2A to 2E show configurations of the functional blocks used in the appliance control system of FIGS. 1A to 1G;

FIGS. 3A to 3H show configurations of the functional block sequences used in the appliance control system of FIGS. 1A to 1G;

FIG. 4 shows an overview of the operation of the appliance of FIGS. 1A to 1G;

FIG. 5 shows another configuration of the appliance control system of FIGS. 1A to 1G;

FIG. 6 shows a configuration of a user apparatus of FIG. 5;

FIG. 7 shows a configuration of an appliance of FIG. 5;

FIG. 8 shows a target temperature curve received by a receiver of FIG. 6;

FIG. 9 shows an overview of processing in a processor of FIG. 6;

FIG. 10 shows an input screen of additional information displayed on a display of FIG. 6;

FIG. 11 shows the additional information received by the receiver of FIG. 6;

FIG. 12 shows a data structure of a database stored in a storage apparatus of FIG. 5;

FIGS. 13A and 13B show overviews of another processing in a processor of FIG. 7;

FIG. 14 shows still another overview of processing in the processor of FIG. 6;

FIG. 15 is a flowchart showing a conversion procedure by the user apparatus of FIG. 5;

FIG. 16 is a flowchart showing another conversion procedure by the user apparatus of FIG. 5;

FIGS. 17A and 17B show overviews of modification processing of a functional block sequence by the user apparatus of FIG. 5;

FIG. 18 is a flowchart showing a modification procedure by the user apparatus of FIG. 5;

FIGS. 19A and 19B show overviews of creation of a functional block sequence by a user apparatus according to Modification 1 and Modification 2;

FIG. 20 is a flowchart showing a conversion procedure by the user apparatus in Modification 1; and

FIG. 21 is a flowchart showing a modification procedure by the user apparatus in Modification 2.

### DETAILED DESCRIPTION

The invention will now be described by reference to the preferred embodiments. This does not intend to limit the scope of the present invention, but to exemplify the invention.

All of the embodiments described below show preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features shown in the figures are denoted by identical symbols, and a duplicate description is omitted or simplified. Hereinafter, embodiments will be described in an order of (1) overviews of functional blocks and functional block sequences, (2) configurations of appliance control system, (3) creation of functional block sequences, (4) modification of functional block sequences, (5) Modification 1, and (6) Modification 2.

### (1) Overviews of Functional Blocks and Functional Block Sequences

In household electrical/mechanical appliances such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

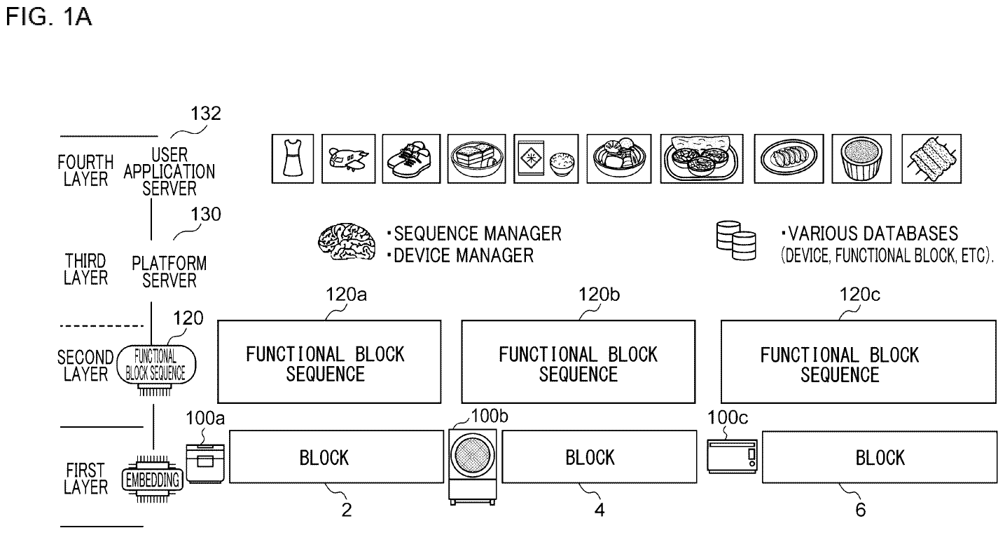

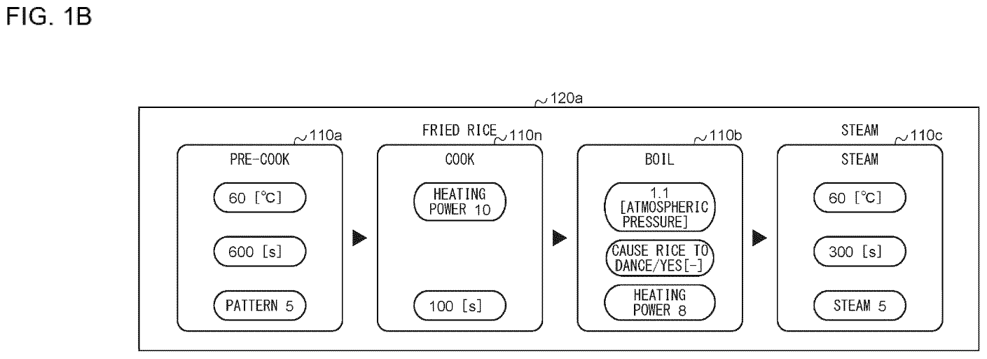

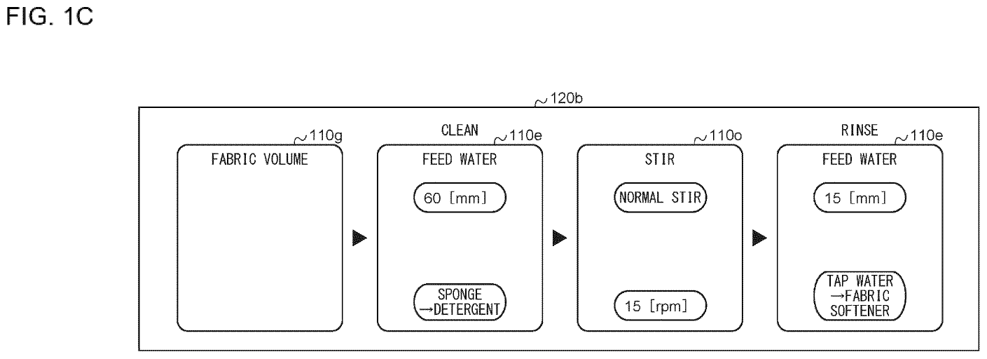

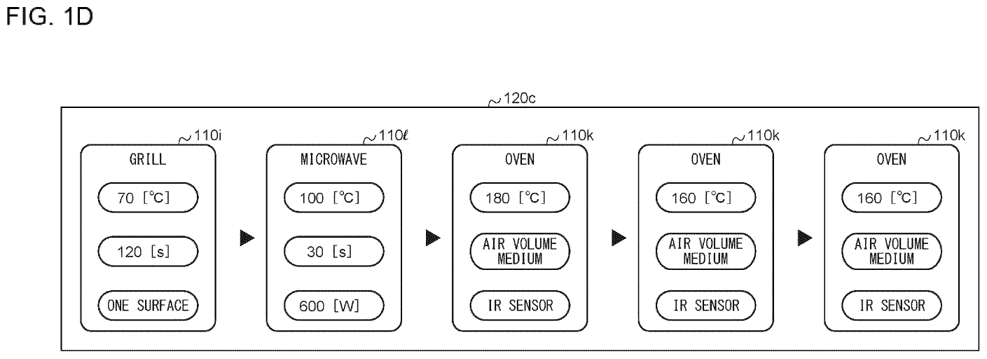

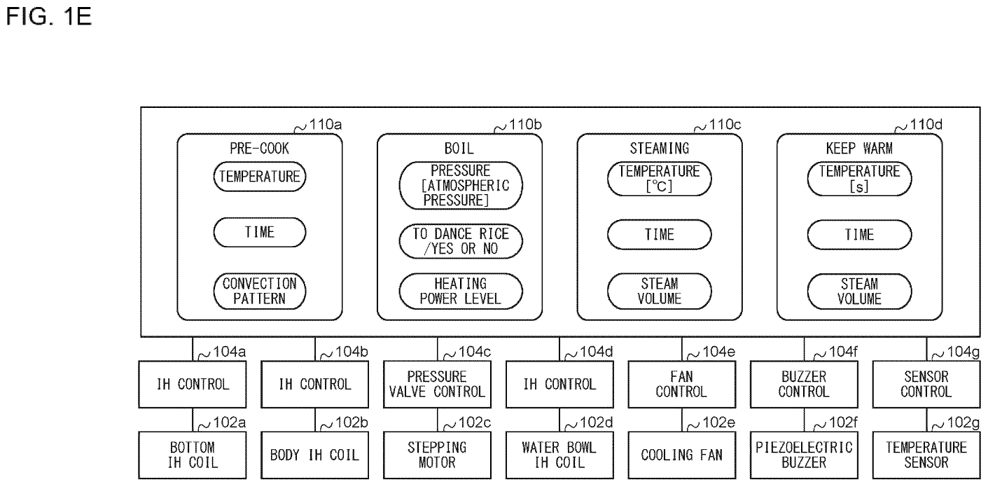

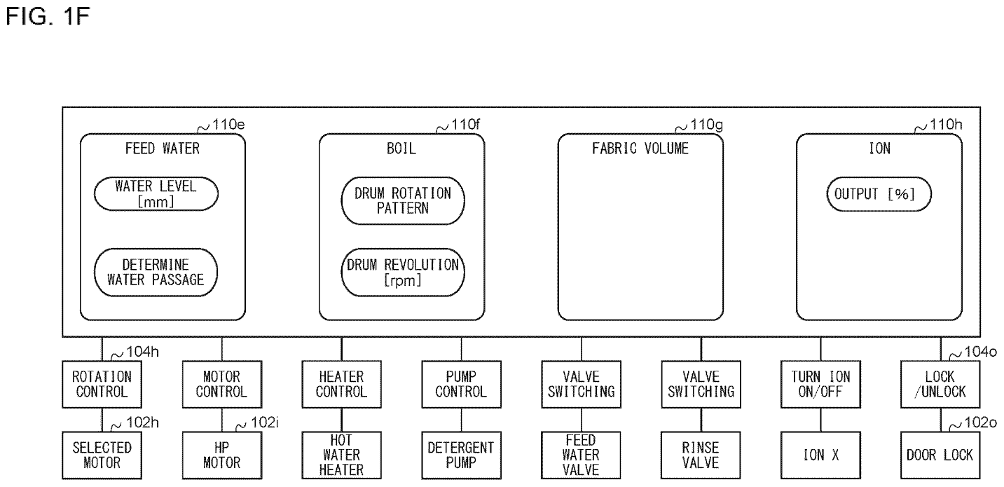

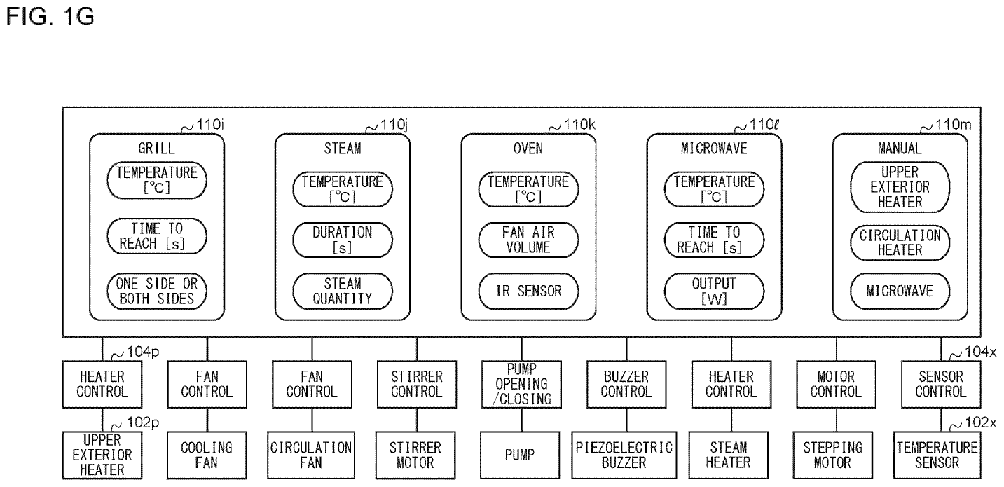

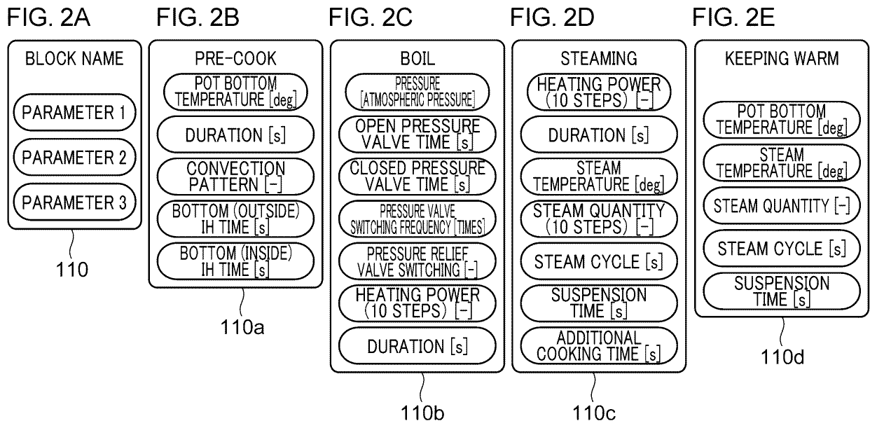

FIGS. 1A to 1G show configurations of an appliance control system 1000. In the appliance control system 1000, a four-layer model composed of the first to fourth layers is defined. In the first layer, the configuration of an appliance 100 is defined. The appliance 100 is, for example, a rice cooker (appliance 100a), a washing machine (appliance 100b), and a microwave oven (appliance 100c). The appliance 100 is not limited thereto. Each appliance 100 includes a block 2 (FIG. 2E), a block 4 (FIG. 2F), a block 6 (FIG. 2G), a plurality of components 102, a plurality of drivers 104, and a plurality of functional blocks 110.

The component 102 is a hardware element constituting a unit derived from dividing the operation (actuation/sensing) of the appliance 100 and includes an actuator and a sensor that execute the function of the appliance 100. The actuator is an output device and the sensor is an input device. The actuator includes, for example, a bottom IH (Induction Heating) coil (component 102a), a body IH coil (component 102b), a stepping motor (component 102c), a water bowl IH coil (component 102d), a cooling fan (component 102e), and a piezoelectric buzzer (component 102f) in the rice cooker (appliance 100a). The sensor is, for example, a temperature sensor (component 102g) in the rice cooker (appliance 100a). The component 102 included in the rice cooker (appliance 100a) is not limited to these, and the washing machine (appliance 100b) and the microwave oven (appliance 100c) are similarly configured.

The driver 104 is software for directly controlling the component 102. IH control (driver 104) in the rice cooker (appliance 100a) controls the bottom IH coil (component 102a). Further, IH control (driver 104b) controls the body IH coil (component 102b), pressure valve control (driver 104c) controls the stepping motor (component 102c), and IH control (driver 104d) controls the water bowl IH coil (component 102d). Further, fan control (driver 104e) controls the cooling fan (component 102e), buzzer control (driver 104f) controls the piezoelectric buzzer (component 102f), and sensor control (driver 104g) controls the temperature sensor (component 102g). The driver 104 included in the rice cooker (appliance 100a) is not limited to these, and the washing machine (appliance 100b) and the microwave oven (appliance 100c) are similarly configured.

The functional block 110 is a software interface (API: Application Programming Interface) associated with one or more drivers 104 to cause one or more components 102 to operate. The functional block 110 can receive one or more parameters for controlling the operation of the (each) component 102. Details of the functional block 110 will be described later.

In the second layer, a functional block sequence 120 in which one or more functional blocks 110 are arranged in the order of operation is defined to cause the appliance 100 to execute an intended process. That is, the functional block sequence 120 defines the order of execution of one or more functional blocks 110. The intended process is defined according to the appliance 100, and is, for example, cooking in the case of the rice cooker (appliance 100a) and the microwave oven (appliance 100c) and washing in the case of the washing machine (appliance 100b). The functional block sequence 120a (FIG. 2B) is used in the rice cooker (appliance 100a), the functional block sequence 120b (FIG. 2C) is used in the washing machine (appliance 100b), and the functional block sequence 120c (FIG. 2D) is used in the microwave oven (appliance 100c). The appliance 100 executes the operation in the order of the functional blocks 110 arranged in the functional block sequence 120. Therefore, it is possible to update the function/operation of the appliance 100 by changing the arrangement of the functional blocks 110 or changing a parameter set in the functional block 110. Details of the functional block sequence 120 will be described later.

In the third layer, a platform server 130 that manages various information in the appliance control system 1000 is arranged. The platform server 130 includes a sequence manager, a device manager, and various databases. The sequence manager manages the functional block sequence 120, the device manager manages the registered information on the appliance 100 that can use the functional block sequence 120, and the various databases manage user information on users who can use the functional block sequence 120.

In the fourth layer, a user application server 132 in which each functional block sequence 120 is presented as a user application is arranged. The functional block sequence 120 presented in the user application server 132 is downloaded to the appliance 100. The downloaded functional block sequence 120 is enabled in the appliance 100. When a further functional block sequence 120 is downloaded to the appliance 100, the further functional block sequence 120 is enabled in the appliance 100.

The third and fourth layers of the appliance control system 1000 may be integrated. In that process, the platform server 130 and the user application server 132 are integrally configured. Alternatively, the third and fourth layers in the appliance control system 1000 may be arranged in the same layer. Alternatively, the third and fourth layers in the appliance control system 1000 may be omitted. In that process, the functional block sequence 120 is downloaded to the appliance 100 from the user apparatus (not shown) owned by the user.

FIGS. 2A to 2E show configurations of the functional block 110 used in the appliance control system 1000. FIG. 2A shows the basic configuration of the functional block 110. The functional block 110 is defined in a functional unit that the appliance 100 can execute and has a “block name” determined by the detail of the function. A plurality of parameters determined by the function can be set in the functional block 110. Each parameter set in the functional block 110 is output to the driver 104. When the driver 104 receives the parameter from the functional block 110, the driver 104 controls the operation of the component 102 according to the parameter.

FIG. 2B shows a functional block 110a of “pre-cook” in the rice cooker (appliance 100a) of FIG. 1A. In the functional block 110a of “pre-cook”, parameters including pot bottom temperature, duration, convection pattern, bottom (outside) IH time, and bottom (inside) IH time can be set. FIG. 2C shows a functional block 110b of “boil” in the rice cooker (appliance 100a) of FIG. 1A, FIG. 2D shows a functional block 110c of “steam” in the rice cooker (appliance 100a) of FIG. 1A, and FIG. 2E shows a functional block 110d of “keep warm”. A plurality of parameters can be set in each of the functional block 110b to the functional block 110d as well. The same applies to the functional block 110 in the washing machine (appliance 100b) and the microwave oven (appliance 100c) of FIG. 1A.

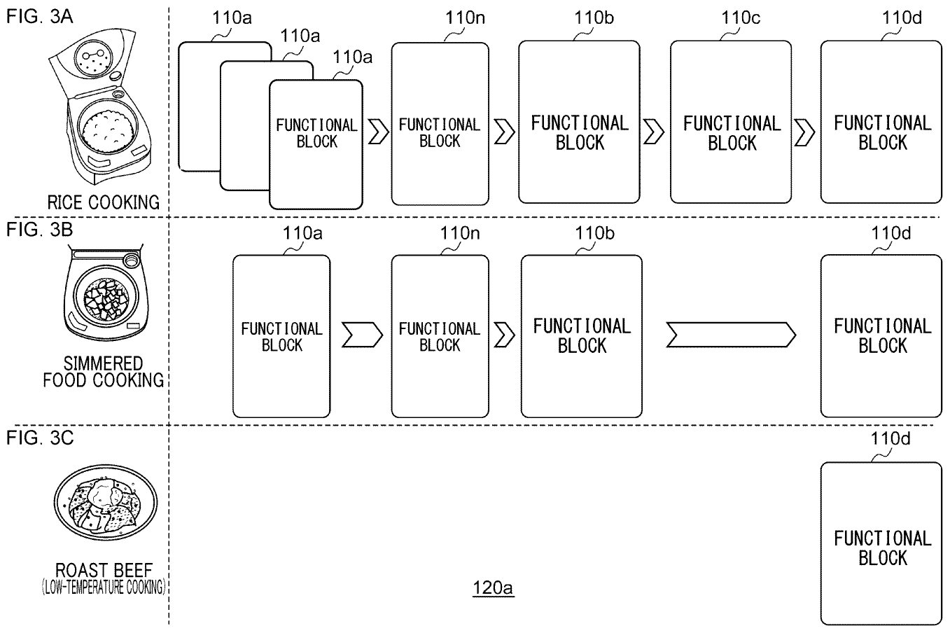

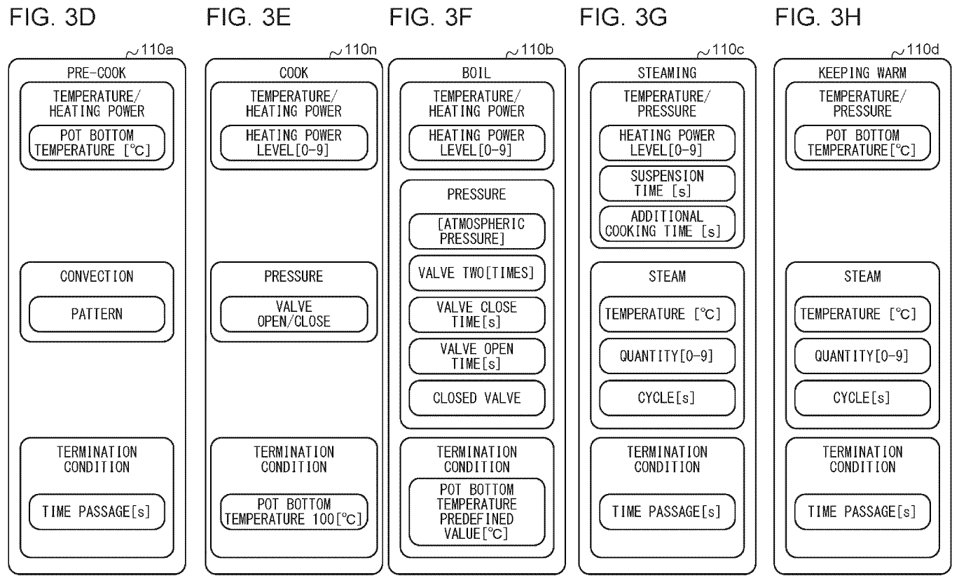

FIGS. 3A to 3H show configurations of the functional block sequence 120 used in the appliance control system 1000 and, particularly, the functional block sequence 120a used in the rice cooker (appliance 100a) of FIG. 1A. FIG. 3A shows a sequence for “rice cooking”, FIG. 3B shows a sequence for “simmered food cooking”, and FIG. 3C shows a sequence for “roast beef (low temperature cooking)”.

In the sequence for “rice cooking” shown in FIG. 3A, three “pre-cook” functional blocks 110a (FIG. 3D), a “cook” functional block 110n (FIG. 3E), the “boil” functional block 110b (FIG. 3F), the “steam” functional block 110c (FIG. 3G), and the “keep warm” functional block 110d (FIG. 3H) are arranged in order. In the three “pre-cook” functional blocks 110a, mutually different parameters are set. By thus arranging the three “pre-cook” functional blocks 110a in which mutually different parameters are set in order, a three-step pre-cooking can be executed.

In the sequence for “simmered food cooking” shown in FIG. 3B, the “pre-cook” functional block 110a, the “cook” functional block 110n, the “boil” functional block 110b, and the “keep warm” functional block 110d are arranged in order. The sequence for “roast beef (low temperature cooking)” shown in FIG. 3C includes the “keep warm” functional block 110d. By thus changing the type, arrangement, and parameters of the functional block 110 used, it is possible to execute processes directed to different purposes of “rice cooking”, “simmered food cooking”, and “roast beef (low-temperature cooking)”. The same applies to the functional block sequence 120 in the washing machine (appliance 100b) and the microwave oven (appliance 100c) of FIG. 1A.

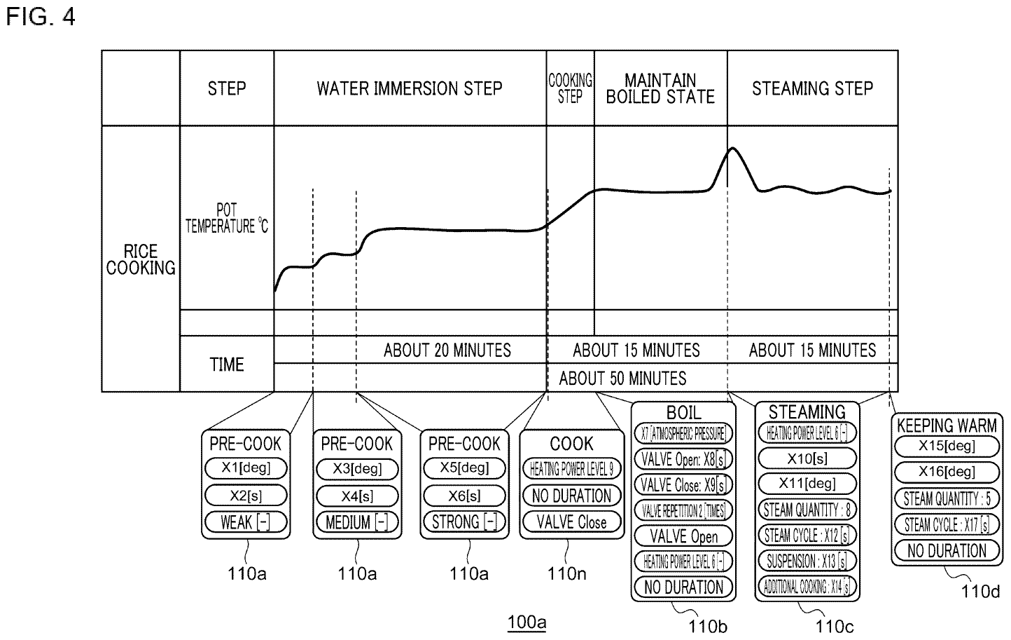

FIG. 4 shows an overview of the operation of the appliance 100 and, particularly, the rice cooker (appliance 100a) of FIG. 1A. This shows the operation of the appliance 100a according to the sequence for “rice cooking” in FIG. 3A. In the water immersion step, the three “pre-cook” functional blocks 110a with mutually different parameters set are executed in order so that the components 102 corresponding to them operate according to the parameters. As a result, the pot temperature increases in a stepwise manner over time. Following this, the “cook” functional block 110n, the “boil” functional block 110b, the “steam” functional block 110c, and the “keep warm” functional block 110d are executed in order so that the components 102 corresponding to them operate according to the parameters. That is, rice is cooked in the appliance 100a by executing a plurality of functional blocks 110 in order.

### (2) Configuration of Appliance Control System

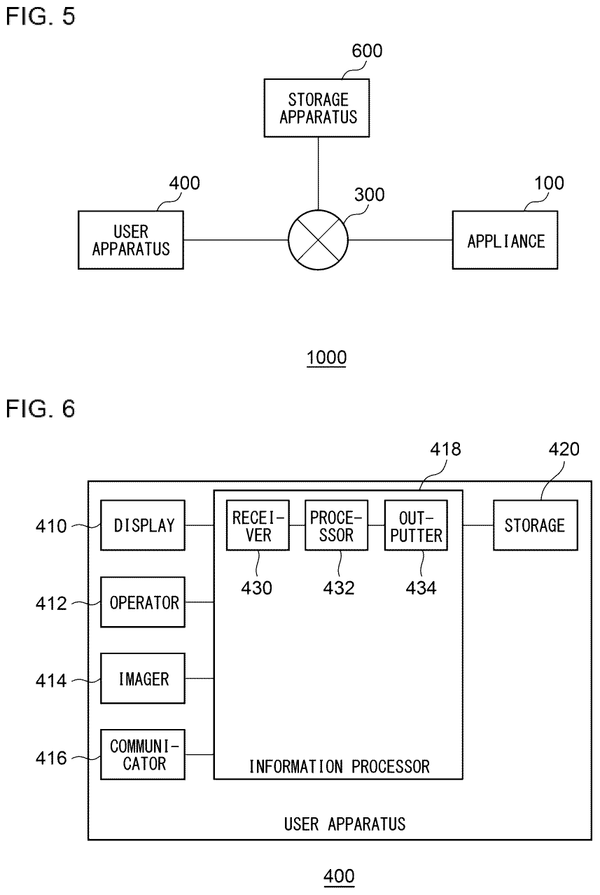

FIG. 5 shows another configuration of the appliance control system 1000. The appliance control system 1000 includes the appliance 100, a network 300, a user apparatus 400, and a storage apparatus 600.

The appliance 100 is, for example, a rice cooker shown in FIG. 1A. The appliances 100 execute the processing of the first layer of FIG. 1A. The appliance control system 1000 may include a plurality of types of appliances 100. The appliance 100 is connected to the network 300. In network 300, either wired communication, wireless communication, or a combination of the wired communication and the wireless communication may be carried out. The user apparatus 400 and the storage apparatus 600 are also connected to the network 300.

The storage apparatus 600 is, for example, a hard disk drive (HDD) or a solid state drive (SSD), and can store electronic information. The storage apparatus 600 stores a database used in the user apparatus 400. The database will be described later.

The user apparatus 400 is a terminal apparatus used by a user, and is, for example, a smartphone, a tablet terminal, or a PC. The user apparatus 400 creates a functional block sequence 120 to be executed by the appliance 100 in response to a manipulation of the user. The user apparatus 400 transmits the created functional block sequence 120 to the appliance 100 via the network 300. If receiving the functional block sequence 120 from the user apparatus 400, the appliance 100 performs processing according to the functional block sequence 120.

FIG. 6 shows a configuration of the user apparatus 400. The user apparatus 400 includes a display 410, an operator 412, an imager 414, a communicator 416, an information processor 418, and a storage 420. The information processor 418 includes a receiver 430, a processor 432, and an outputter 434.

The display 410 displays information from the information processor 418. The operator 412 is an interface capable of receiving an input from the user, and is, for example, a button. In addition, the display 410 and the operator 412 may be integrated as a touch panel. The operator 412 outputs the received input to the information processor 418. The imager 414 is, for example, a camera and has an imaging function. The imager 414 outputs a captured image to the information processor 418. The communicator 416 is connected to the network 300 and communicates with the appliance 100 or the storage apparatus 600 via the network 300.

The information processor 418 executes a process in the user apparatus 400, for example, a process of creating or modifying the functional block sequence 120 by executing a program stored in the storage 420. Although the process of creating or modifying the functional block sequence 120 executed in the information processor 418 will be described later, the information processor 418 uses the display 410, the operator 412, and the imager 414 in the process. The communicator 416 transmits the functional block sequence 120 created or modified in the information processor 418 to the appliance 100 via the network 300.

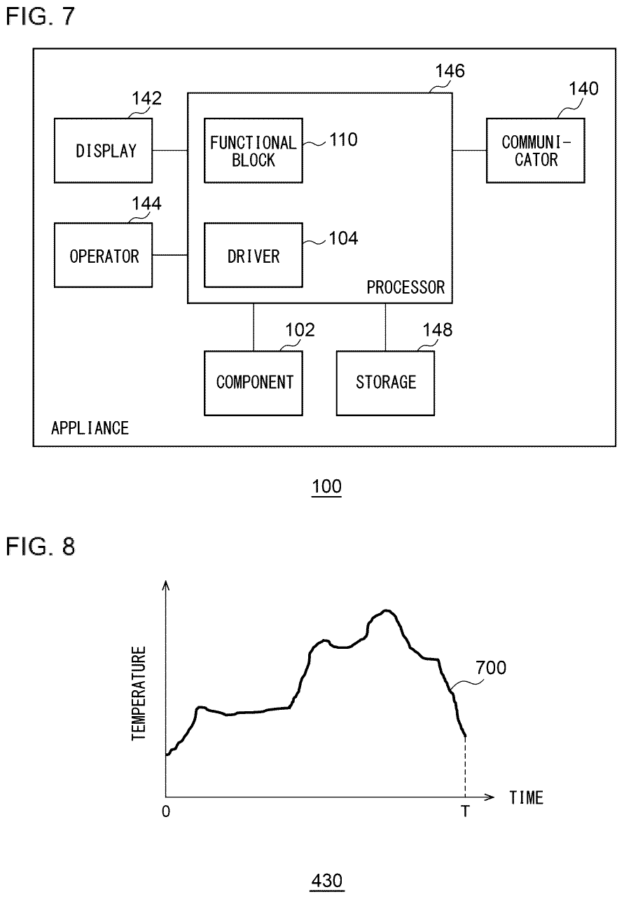

FIG. 7 shows a configuration of the appliance 100. The appliance 100 includes the component 102, a communicator 140, a display 142, an operator 144, a processor 146, and a storage 148. The processor 146 includes the functional block 110 and the driver 104. The appliance 100 is a household electrical/mechanical appliance such as a rice cooker, a washing machine, a microwave oven, or a toaster. A plurality of components 102, a plurality of drivers 104, and a plurality of functional blocks 110 are provided as shown in FIGS. 1B to 1G, but only a respective one is shown here for the sake of clarity of the drawings.

The communicator 140 is connected to the network 300 and communicates with the user apparatus 400 via the network 300. The display 142 displays information from the processor 146. The operator 144 is an interface capable of receiving an input from a user, and is, for example, a button. In addition, the display 142 and the operator 144 may be integrated as a touch panel. The operator 144 outputs the received input to the processor 146.

The processor 146 receives the functional block sequence 120 received by the communicator 140 from the user apparatus 400. The processor 146 causes the component 102 to operate via the driver 104 in the order of the functional blocks 110 in the functional block sequence 120.

### (3) Creation of Functional Block Sequences

The operations of the appliance 100 can be freely changed by changing the arrangement of the functional blocks 110 in the functional block sequence 120 or the parameter set to each of the functional blocks 110. Meanwhile, for a user who has insufficient understanding of the operations of each of the functional blocks 110, it is difficult to create the functional block sequence 120 by arranging the plurality of functional blocks 110 or setting the parameter of each of the functional blocks 110.

In the present embodiment, in order to enable intuitive creation of the functional block sequence 120 by the user, a temperature curve indicating a temperature change of the appliance 100 over time is introduced. The user creates a temperature curve to be achieved in the appliance 100, that is, a temperature curve to be a target of an operation of the appliance 100 as a target temperature curve. For example, in a case where the display 410 and the operator 412 of the user apparatus 400 are integrated as a touch panel, the user draws the target temperature curve by handwriting on the touch panel. If receiving the target temperature curve handwritten by the user, the operator 412 outputs the target curve as image data to the information processor 418. Alternatively, the user draws the target temperature curve by handwriting on a paper surface. The imager 414 of the user apparatus 400 captures the target temperature curve on the paper surface. The imager 414 outputs the captured target temperature curve to the information processor 418 as image data.

The receiver 430 of the information processor 418 receives the target temperature curve of the image data from the operator 412 or the imager 414. The receiver 430 recognizes the target temperature curve as data indicating the temperature change of the appliance 100 over time by executing an image recognition process on the image data. FIG. 8 shows a target temperature curve 700 received by the receiver 430. The horizontal axis represents time, and the vertical axis represents a temperature of the appliance 100. The target temperature curve 700 indicates a temperature that changes over time. Returning to FIG. 6. The receiver 430 outputs the target temperature curve 700 to the processor 432.

The processor 432 receives the target temperature curve 700 from the receiver 430. The processor 432 converts the received target temperature curve 700 into the functional block sequence 120 to be executed by the appliance 100. The conversion process in the processor 432 is performed in an order of the following (i) to (iii).
(i) The processor 432 creates the functional block sequence 120 in which the plurality of functional blocks 110 are arranged while changing the arrangement of the functional blocks 110 and at least one of the parameters of the functional blocks 110.
(ii) The processor 432 acquires temperature curves (hereinafter, referred to as “estimated temperature curves”) in a case where the appliance 100 is caused to execute the created functional block sequence 120.
(iii) The processor 432 searches for an estimated temperature curve approaching the target temperature curve 700, and acquires the functional block sequence 120 corresponding to the estimated temperature curve detected. It can also be said that the functional block sequence 120 in which the target temperature curve 700 approaches the estimated temperature curve is searched for.

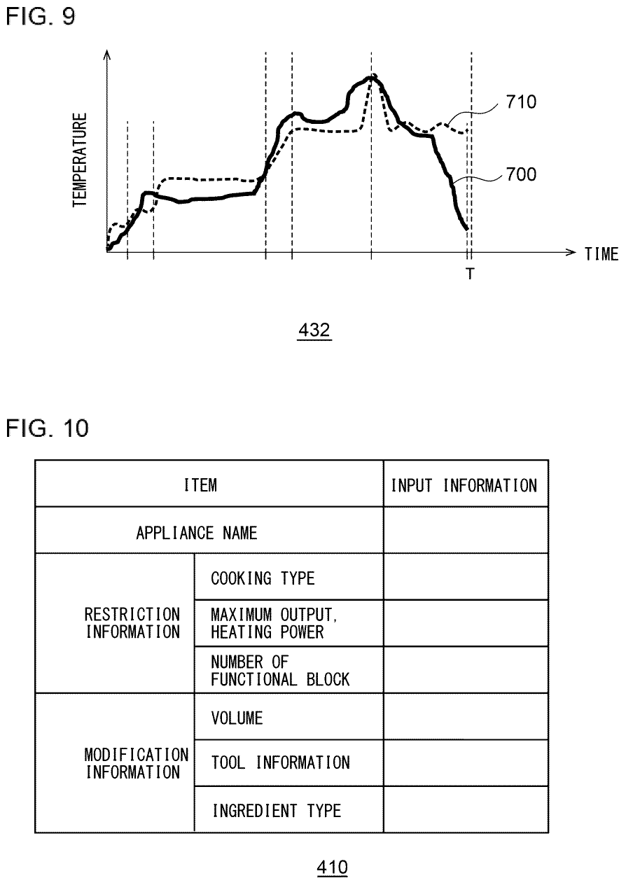

FIG. 9 shows an overview of a process in the processor 432, in particular, the process of (iii). As in FIG. 8, the horizontal axis represents the time, and the vertical axis represents the temperature of the appliance 100. In addition, the target temperature curve 700 is the same as that in FIG. 8. An estimated temperature curve 710 is acquired in (ii). If the estimated temperature curve 710 approaches the target temperature curve 700, it is possible to acquire the functional block sequence 120 capable of achieving a state close to that of the target temperature curve 700. Bringing the estimated temperature curve 710 to approach the target temperature curve 700 corresponds to shortening a distance between the target temperature curve 700 and the estimated temperature curve 710. The distance is indicated as, for example, an area between the target temperature curve 700 and the estimated temperature curve 710. If the target temperature curve 700 is represented as f (t) and the estimated temperature curve 710 is represented as g (t), the distance L (f, g) is expressed as follows.

$$< IMG SRC = {}^{″} PA - 70632 WO number 1. {bmp}^{″} > \qquad [ Math . 1 ]$$

In other words, the processor 432 assembles the plurality of functional blocks 110 to achieve the estimated temperature curve 710 in which an area of the distance L (f, g) is reduced. Therefore, the processor 432 determines the number and the types of the functional blocks 110 and the parameters of the functional blocks 110 in (i), acquires the estimated temperature curve 710 in (ii), and calculates the distance between the estimated temperature curve 710 and the target temperature curve 700 in (iii). In addition, the processor 432 searches for the functional block sequence 120 having a minimum distance by searching for the number and the types of the functional blocks 110 and the parameters of the functional blocks 110 as variables.

Hereinafter, the processes of (i) to (iii) in the processor 432 will be described in more detail.

### Process of (i)

For example, the processor 432 creates a plurality of functional block sequences 120 while changing the number and the types of the functional blocks 110 and each of the parameters of the functional blocks 110 in various ways. According to such process, since the number of the functional block sequences 120 to be created increases, a processing amount of the processor 432 tends to increase. In order to suppress an increase in the processing amount of the processor 432, the following process may be executed.

The information processor 418 causes the display 410 to display a screen (hereinafter, referred to as an “input screen”) for receiving additional information on the target temperature curve 700 from the user. FIG. 10 shows an input screen of the additional information displayed by the display 410. The additional information includes an appliance name indicating a name of the appliance 100, restriction information indicating a restriction in creating the functional block sequence 120, and correction information indicating correction content in acquiring the estimated temperature curve 710 from the functional block sequence 120. The restriction information is information for reducing the number and the types of the functional blocks 110 and options of the parameters of the functional blocks 110, and is, for example, information specifying an upper limit or a lower limit. The restriction information includes, for example, a cooking type (for example, simmer, cook, grill, or fry), a maximum output, heating power, and the number of the functional blocks 110 included in the functional block sequence 120. The correction information is information for correcting a corresponding temperature curve in a case where a default temperature curve is defined for each of the functional blocks 110. The correction information includes, for example, a volume (for example, for 1 person, for 2 persons, or 3 L), tool information (for example, a size of a pot or a type of the pot), and an ingredient type. In a case where there is corresponding information, the user inputs the information in an input information field using the operator 412. Returning to FIG. 6.

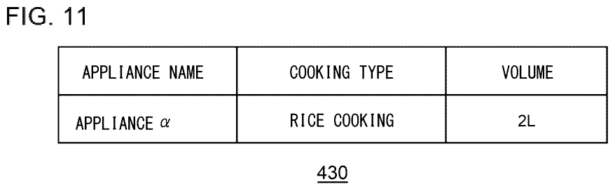

The receiver 430 receives the additional information including at least one of the appliance name, the restriction information, and the correction information together with the target temperature curve 700 from the operator 412. FIG. 11 shows additional information received by the receiver 430. The additional information includes an appliance name “appliance α”, a cooking type “rice cooking”, and a volume “2 L”. The receiver 430 outputs the additional information to the processor 432.

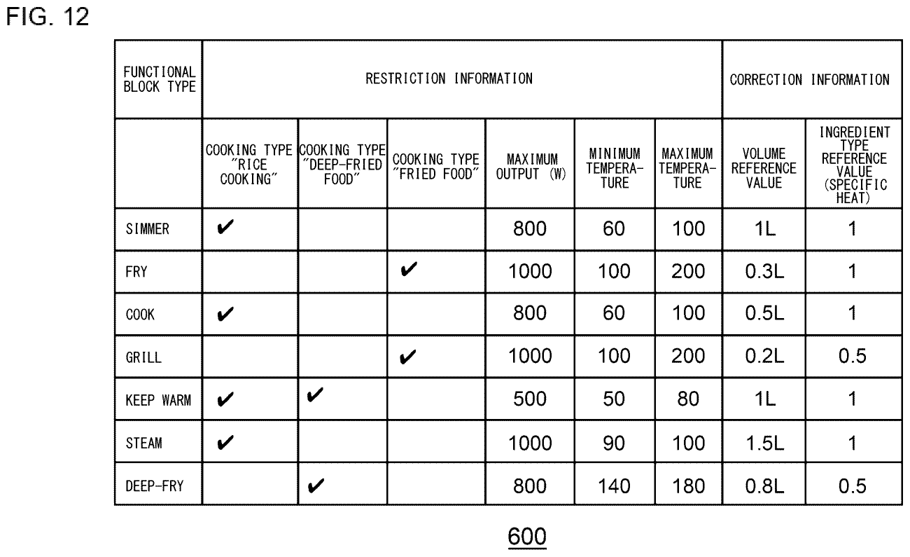

FIG. 12 shows a data structure of a database stored in the storage apparatus 600. This indicates a database for one type of the appliance 100, for example, the appliance α, and the database is stored for each of the appliances 100. In the database, the type of the functional block, the restriction information, and the correction information are associated with each other. The type of the functional block indicates a list of the functional blocks 110 that can be executed in the appliance 100. The functional blocks 110 other than the functional blocks 110 shown in FIG. 12 may be included.

Some of these functional blocks 110 are selected according to the cooking type. For example, the functional blocks 110 of “simmer”, “cook”, “keep warm”, and “steam” are selected for the cooking type “rice cooking”. In a case where a cooking type “deep-fried food” is designated in the additional information, the functional blocks 110 of “keep warm” and “deep fry” are selected, respectively. In a case where the cooking type “fried food” is designated in the additional information, the functional blocks 110 of “fry” and “grill” are selected, respectively. Cooking types other than those shown in FIG. 12 may be included.

A maximum output, a minimum temperature, a maximum temperature, a volume reference value, and an ingredient type reference value (specific heat) include default values set for each of the functional blocks 110. For example, a maximum output “800 W”, a minimum temperature “60° C.”, a maximum temperature “100° C.”, a volume reference value “1 L”, and an ingredient type reference value (specific heat) “1” are set as default values for the functional block 110 of “simmer”. The same applies to other functional blocks 110. Returning to FIG. 6.

The processor 432 of the user apparatus 400 receives the additional information from the receiver 430. The processor 432 acquires a database corresponding to the appliance name included in the additional information from the storage apparatus 600 via the communicator 416. In a case where the additional information does not include the appliance name, the processor 432 acquires a database independent of a specific appliance 100 from the storage apparatus 600 via the communicator 416. The processor 432 selects one or more functional blocks 110 corresponding to the cooking types included in the additional information with reference to the acquired database. In a case where the “rice cooking” is specified as the cooking type included in the additional information, the processor 432 selects the functional blocks 110 of “simmer”, “cook”, “keep warm”, and “steam”, respectively. In other words, the types of the functional blocks 110 are limited by the additional information. In a case where the number of the functional blocks 110 included in the functional block sequence 120 is included in the additional information, the processor 432 selects the specified number of the functional blocks 110. In other words, the number of the functional blocks 110 is limited by the additional information.

The processor 432 creates the functional block sequence 120 by combining the functional blocks 110 while changing the arrangement of the selected one or more functional blocks 110 and at least one of the parameters of the functional blocks 110. For example, the functional block sequence 120 is created. In the functional block sequence 120, the functional block 110 of “cook”, the functional block 110 of “cook”, the functional block 110 of “simmer”, the functional block 110 of “steam”, and the functional block 110 of “keep warm” are arranged in this order. In addition, the functional block sequence 120 is created. In the functional block sequence 120, the functional block 110 of “simmer”, the functional block 110 of “cook”, the functional block 110 of “steam”, and the functional block 110 of “keep warm” are arranged in this order. In other words, the functional blocks 110 of “grill” and the like are not used and the arrangement of the functional blocks 110 is limited according to the additional information.

The parameters such as the maximum output, the minimum temperature, and the maximum temperature of each of the functional blocks 110 are limited to the default values indicated in the database. Further, in a case where the additional information includes the parameters such as the maximum output, the parameters included in the additional information are used for each of the functional blocks 110. In other words, the parameters of the functional blocks 110 are limited by the additional information.

### Process of (ii)

As described above, the default values of the volume reference value and the ingredient type reference value (specific heat) are indicated in each of the functional blocks 110 in the database. A temperature curve in a case where each of the functional blocks 110 operates according to the default values of the volume reference value and the ingredient type reference value (specific heat) is derived in advance, and the temperature curve for each of the functional blocks 110 is also stored in the database.

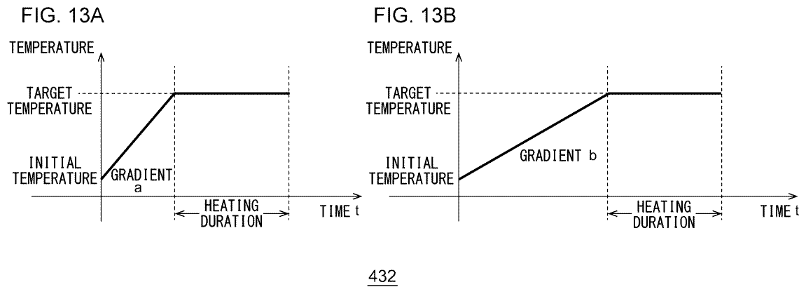

FIGS. 13A and 13B show overviews of another process in the processor 432. FIG. 13A shows a temperature curve for the functional block 110 of “simmer” in a case where the volume reference value and the ingredient type reference value (specific heat) are the default values. For example, this temperature curve rises from an initial temperature to a target temperature with a gradient a over time, and then the target temperature is maintained for heating duration. The gradient a is expressed as follows.

$$Gradient a = maximum output / ( volume * specific heat ) * constant \qquad Expression ( 2 )$$

If the maximum output is “800 W”, the volume reference value is “1 L”, and the ingredient type reference value (specific heat) is “1”, the gradient a is expressed as follows.

$$Gradient a = 800 * constant \qquad Expression ( 3 )$$

In a case where the volume “2 L” is included in the additional information, the processor 432 corrects the temperature curve shown in FIG. 13A to the temperature curve shown in FIG. 13B. For example, this temperature curve rises from an initial temperature to a target temperature with a gradient b over time, and then the target temperature is maintained for heating duration. The gradient b is expressed as follows.

$$Gradient b = maximum output / ( volume * specific heat ) * constant \qquad Expression ( 4 )$$

In a case where “2 L” is input as the volume, the gradient b is expressed as follows.

$$Gradient b = 800 / 2 * constant \qquad Expression ( 5 )$$

Comparing Expression (3) with Expression (4), the gradient b is ½ of the gradient a. In other words, if the volume doubles, the gradient becomes ½, and if the gradient is ½, the time taken to reach the target temperature doubles. The processor 432 creates the estimated temperature curve 710 by connecting the temperature curves for the plurality of functional blocks 110 included in the functional block sequence 120.

### Process of (iii)

Among the plurality of the arranged functional blocks 110, the functional blocks 110 arranged later have a characteristic of affecting no functional blocks 110 arranged before. Therefore, when searching for the functional block sequence 120 in which the estimated temperature curve 710 approaches the target temperature curve 700, the processor 432 determines the functional block sequence 120 in an order from the functional blocks 110 on a front side to the functional blocks 110 on a rear side of the functional block sequence 120.

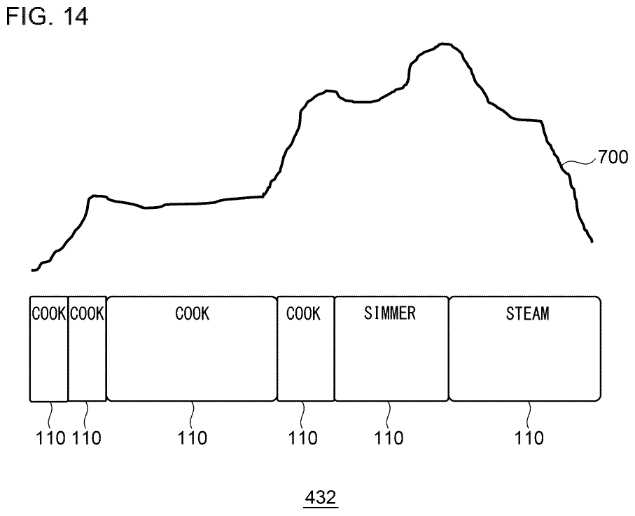

FIG. 14 shows still another overview of the process in the processor 432. As an example, in the functional block sequence 120, the functional block 110 of “cook”, the functional block 110 of “cook”, the functional block 110 of “cook”, the functional block 110 of “cook”, the functional block 110 of “simmer”, and the functional block 110 of “steam” are arranged in order. The processor 432 compares a portion (hereinafter, referred to as a “head portion”) corresponding to the first functional block 110 (functional block 110 of “cook”) in the estimated temperature curve 710 with the target temperature curve 700. If a difference between the two curves is larger than a threshold value, the processor 432 changes the parameters of the first functional block 110 of “cook”, or changes the head portion from the functional block 110 of “cook” to the functional block 110 of “simmer”. In the changed situation, the processor 432 compares the head portion with the target temperature curve 700. If the difference between the two curves is larger than the threshold value, the processor 432 repeatedly executes the change as described above. If the difference therebetween is equal to or less than the threshold value, the processor 432 determines the first functional block 110 at that time.

If determining the first functional block 110, the processor 432 repeats a similar process for a second functional block 110 in the estimated temperature curve 710. Further, if determining the second functional block 110, the processor 432 repeats a similar process for third and subsequent functional blocks 110 in the estimated temperature curve 710. The plurality of functional blocks 110 in a case where a last functional block 110 is determined correspond to the functional block sequence 120 obtained by converting the target temperature curve 700. The outputter 434 outputs the converted functional block sequence 120 to the communicator 416.

The features are implemented in hardware such as a Central Processing Unit (CPU), a memory, or other Large Scale Integrations (LSIs) of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

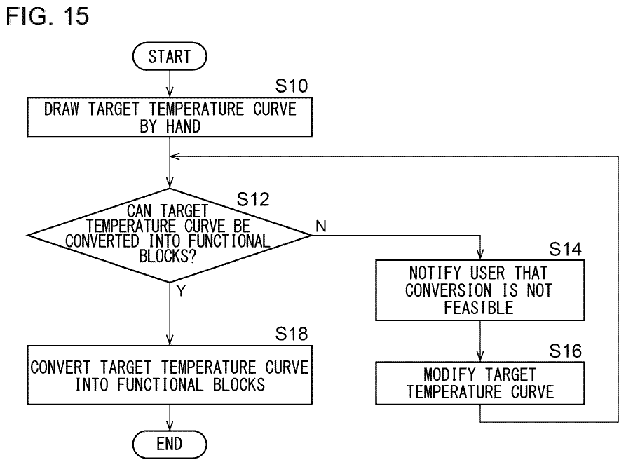

An operation of the appliance control system 1000 having the above configuration will be described. FIG. 15 is a flowchart showing a conversion procedure by the user apparatus 400. The user draws the temperature curve (target temperature curve 700) by hand (S10), and the receiver 430 receives the target temperature curve 700. If the target temperature curve 700 cannot be converted into the functional blocks 110 (N in S12), the information processor 418 notifies, from the display 410, the user that the conversion is not feasible (S14). The case where the conversion is not possible is, for example, a case where the temperature exceeds a limit value, a case where the temperature gradient is too steep, or a case where there is a risk of food poisoning without sterilization. In addition, instead of notifying the user that the conversion is not feasible, the information processor 418 may notify the user of an alternative from the display 410. The alternative is created, for example, by modifying the target temperature curve 700 such that the temperature does not exceed the limit value, and then converting the modified target temperature curve 700 into the functional block sequence 120 by the process described above. If the user modifies the target temperature curve 700 (S16), the receiver 430 receives the target temperature curve 700. The process returns to step 12. If the target temperature curve 700 can be converted into the functional blocks 110 (Y in S12), the processor 432 converts the target temperature curve 700 into the functional blocks 110 (S18).

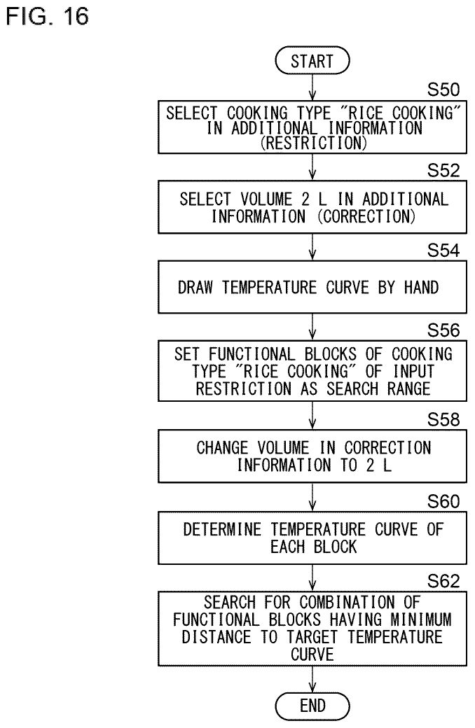

FIG. 16 is a flowchart showing another conversion procedure by the user apparatus 400. The cooking type “rice cooking” is selected in the additional information (restriction) received by the receiver 430 (S50), and the volume 2 L is selected in the additional information (correction) (S52). The user draws the temperature curve (target temperature curve 700) by hand (S54), and the receiver 430 receives the target temperature curve 700. The processor 432 sets the functional blocks 110 of the cooking type “rice cooking” of the input restriction as a search range (S56). The processor 432 changes the volume in the correction information to 2 L (S58). The processor 432 determines the temperature curve for each of the functional blocks 110 (S60). The processor 432 searches for a combination of the functional blocks 110 having a minimum distance to the target temperature curve 700 (S62).

### (4) Modification of Functional Block Sequences

Here, a case of modifying or editing a functional block sequence 120 that has already been created is assumed. Also in this case, it is preferable that the user can intuitively modify the functional block sequence 120. Therefore, the temperature curve is also used in the case of modifying the functional block sequence 120 that has already been created. The temperature curve is expressed as a series of several vertices (spline curve). The temperature curve is modified by changing coordinates of the vertices.

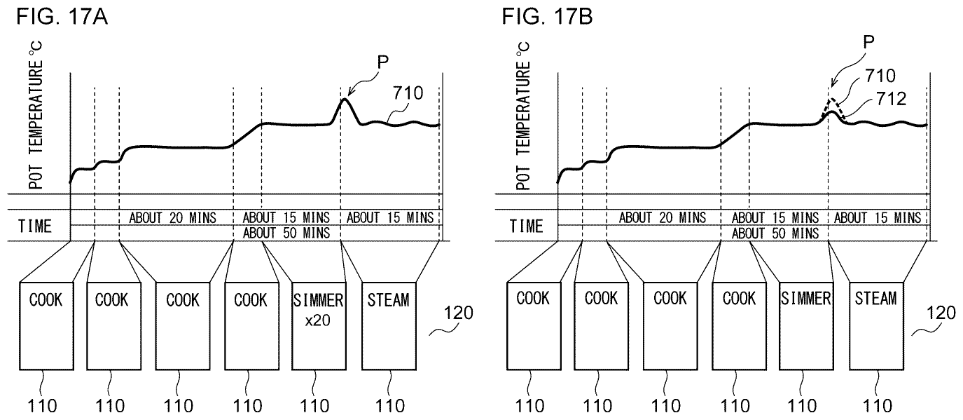

The information processor 418 of the user apparatus 400 causes the display 410 to display the estimated temperature curve 710 for the functional block sequence 120 that has already been created. FIGS. 17A and 17B show overviews of a modification process of the functional block sequence 120 by the user apparatus 400. An upper part of FIG. 17A shows the estimated temperature curve 710 displayed on the display 410, and a lower part of FIG. 17B shows the functional block sequence 120 corresponding to the estimated temperature curve 710. For the functional block sequence 120, in the functional block sequence 120, for example, the functional block 110 of “cook”, the functional block 110 of “cook”, the functional block 110 of “cook”, the functional block 110 of “cook”, the functional block 110 of “simmer”, and the functional block 110 of “steam” are arranged in order. In addition, a parameter “X20” is set in the functional block 110 of “simmer”.

The user manipulates the operator 412 to modify a part of the estimated temperature curve 710, for example, a point P. The receiver 430 receives the modification of the estimated temperature curve 710 from the operator 412. The processor 432 creates a modified temperature curve 712 obtained by modifying the estimated temperature curve 710 to reflect the modification received by the receiver 430. An upper part of FIG. 17B shows the modified temperature curve 712 created in the processor 432. By lowering the temperature at the point P of the estimated temperature curve 710, the modified temperature curve 712 is created.

The processor 432 converts the modified temperature curve 712 into the functional block sequence 120 by executing a process similar to the above process of converting the target temperature curve 700 into the functional block sequence 120. At that time, in order to simplify the modification process, the processor 432 does not change the types or the number of the functional blocks 110 and changes only the parameters of the functional blocks 110. Meanwhile, the processor 432 may change the number or the types of the functional blocks 110. A lower part of FIG. 17B shows the modified functional block sequence 120. The functional blocks 110 included in the functional block sequence 120 are the same as those in the lower part of FIG. 17A, but the parameter of the functional block 110 of “simmer” is changed to “X21”.

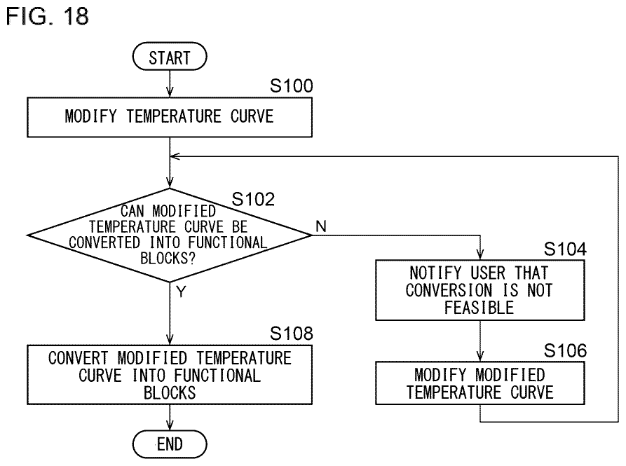

An operation of the appliance control system 1000 having the above configuration will be described. FIG. 18 is a flowchart showing a modification procedure by the user apparatus 400. The user modifies the temperature curve (modified temperature curve 712) (S100) to create the modified temperature curve 712, and the receiver 430 receives the modified temperature curve 712. If the modified temperature curve 712 cannot be converted into the functional blocks 110 (N in S102), the information processor 418 notifies, from the display 410, the user that the conversion is not feasible (S104). If the user modifies the modified temperature curve 712 (S106), the receiver 430 receives the modification of the modified temperature curve 712. The process returns to step 102. If the modified temperature curve 712 can be converted into the functional blocks 110 (Y in S102), the processor 432 converts the modified temperature curve 712 into the functional blocks 110 (S108).

### (5) Modification 1

In (3) creation of functional block sequences described above, the target temperature curve 700 is converted into the functional block sequence 120. Meanwhile, even in a case where the functional block sequence 120 is directly created by combining the functional blocks 110, the estimated temperature curve 710 corresponding to the functional block sequence 120 may be displayed. By displaying the estimated temperature curve 710, the user can easily understand the temperature change, and the user convenience is enhanced.

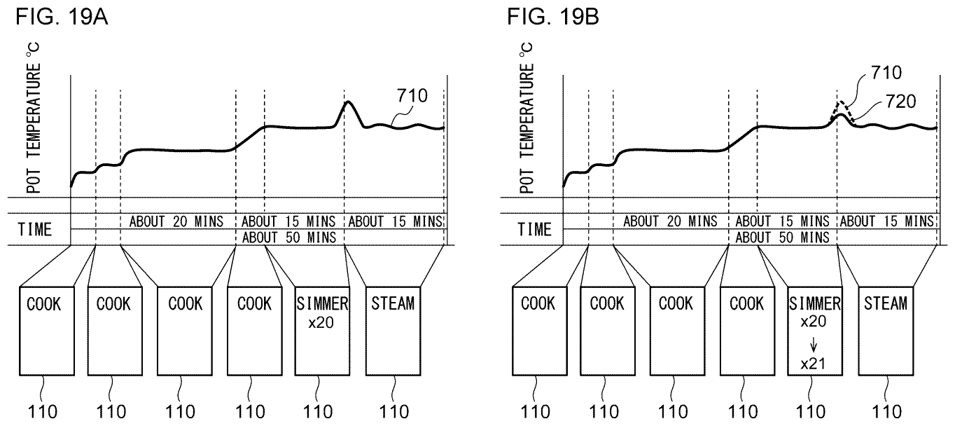

FIG. 19A and 19B show overviews of the creation of the functional block sequence 120 by the user apparatus 400. The user manipulates the operator 412 of the user apparatus 400 to arrange the plurality of functional blocks 110 and sets parameters of each of the functional blocks 110. As a result, the functional block sequence 120 as shown in a lower part of FIG. 19A is created.

The processor 432 of the user apparatus 400 creates the estimated temperature curve 710 in a case where the appliance 100 is caused to execute the created functional block sequence 120 by a process similar to (ii) described above. The processor 432 causes the display 410 to display the created estimated temperature curve 710. An upper part of FIG. 19A shows the estimated temperature curve 710 displayed on the display 410. FIG. 19B will be described later.

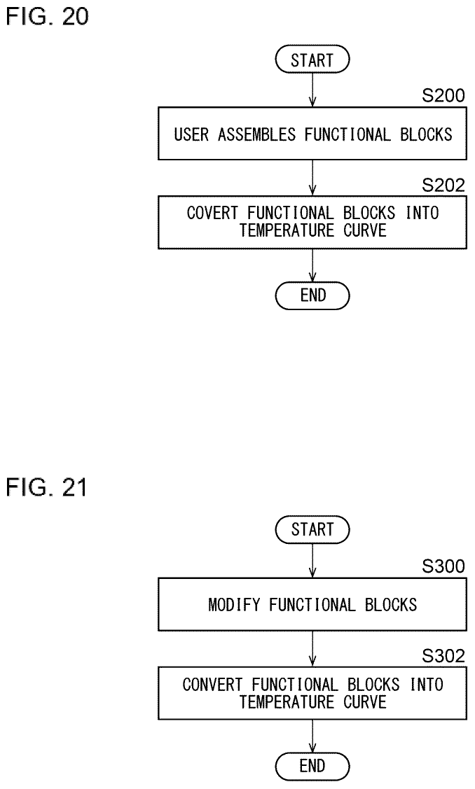

An operation of the appliance control system 1000 having the above configuration will be described. FIG. 20 is a flowchart showing a conversion procedure by the user apparatus 400. The user manipulates the operator 412 to assemble the functional blocks 110 (S200). The processor 432 converts the functional blocks 110 into the temperature curve (estimated temperature curve 710) (S202).

### (6) Modification 2

In (4) modification of functional block sequences described above, the functional block sequence 120 is modified by modifying the estimated temperature curve 710. Meanwhile, even in a case where the functional block sequence 120 is directly modified by modifying the functional blocks 110 included in the functional block sequence 120, the estimated temperature curve corresponding to the modified functional block sequence 120 may be displayed. By displaying the estimated temperature curve, the user can easily understand the temperature change, and the user convenience is enhanced.

The information processor 418 of the user apparatus 400 causes the display 410 to display the functional block sequence 120 that has already been created. The user modifies the displayed functional block sequence 120 by manipulating the operator 412 of the user apparatus 400. FIG. 19B shows the modified functional block sequence 120. The parameter of the functional block 110 of “simmer” is modified from “X20” to “X21”.

The processor 432 of the user apparatus 400 creates an estimated temperature curve 720 in a case where the appliance 100 is caused to execute the modified functional block sequence 120 by a process similar to (ii) described above. The processor 432 causes the display 410 to display the created estimated temperature curve 720. An upper part of FIG. 19B shows the estimated temperature curve 720 displayed on the display 410. The estimated temperature curve 720 is changed in accordance with the modification of the parameter of the functional block 110.

An operation of the appliance control system 1000 having the above configuration will be described. FIG. 21 is a flowchart showing a modification procedure by the user apparatus 400. The user manipulates the operator 412 to modify the functional blocks 110 (S300). The processor 432 converts the functional blocks 110 into the temperature curve (estimated temperature curve 720) (S302).

According to the present embodiment, since the received target temperature curve 700 is output after being converted into the functional block sequence 120, the user can intuitively create the cooking procedure. In addition, the functional block sequence 120 is created while the arrangement of the functional blocks 110 and at least one of the parameters of the functional blocks 110 are changed. The estimated temperature curve 710 for the functional block sequence 120 is acquired, and then the functional block sequence 120 in which the target temperature curve 700 approaches the estimated temperature curve 710 is searched for, so that the conversion can be easily executed.

In addition, since the target temperature curve 700 is created by the handwriting of the user, the user convenience can be enhanced. In addition, since the additional information indicating the restriction in creating the functional block sequence 120 is received, it is possible to simplify the conversion from the target temperature curve 700 to the functional block sequence 120. Further, since the additional information indicating the correction content in acquiring the estimated temperature curve 710 is received, accuracy of the estimated temperature curve 710 can be improved. In addition, since the functional block sequence 120 is determined in the order from the functional blocks 110 on the front side to the functional blocks 110 on the rear side of the functional block sequence 120, the process can be efficiently executed. In addition, if the modification of the estimated temperature curve 710 is received, the modified temperature curve 712 reflecting the modification is converted into functional block sequence 120, so that the user can intuitively modify the cooking procedure. Further, if the conversion from the target temperature curve 700 to the functional block sequence 120 is impossible, a notification that the conversion is impossible is made or an alternative is output, so that the user convenience can be enhanced.

An overview of one aspect of the present disclosure is as follows. An information processing method according to one aspect of the present disclosure includes: a step of receiving, as a target temperature curve, a temperature curve that indicates a temperature change of an appliance over time and that is a target; a step of converting the received target temperature curve into a block sequence in which blocks defined in a functional unit executable by the appliance are arranged in an order of operation; and a step of outputting the converted block sequence. In the conversion step, the block sequence is created while arrangement of the blocks and at least one of parameters of the blocks are changed, a temperature curve in a case where the appliance is caused to execute the created block sequence is acquired as an estimated temperature curve, and the block sequence in which the estimated temperature curve approaches the target temperature curve is searched for.

The target temperature curve may be created by handwriting of a user.

In the reception step, additional information indicating a restriction in creating the block sequence is received together with the target temperature curve.

In the reception step, additional information indicating correction content in acquiring the estimated temperature curve is received together with the target temperature curve.

In the conversion step, the block sequence may be determined in an order from the blocks on the front side to the blocks on the rear side of the block sequence in searching for the block sequence in which the estimated temperature curve approaches the target temperature curve.

The method may further include a step of receiving modification of the temperature curve after converting the target temperature curve into the block sequence. In the conversion step, the temperature curve reflecting the modification may be converted into the block sequence.

In a case where it is determined that, in the conversion step, the conversion from the received target temperature curve to the block sequence is impossible, in the output step, a notification that the conversion is impossible may be made, or an alternative of the block sequence may be output.

Another aspect of the present disclosure is an information processing apparatus. The apparatus includes: a receiver structured to receive, as a target temperature curve, a temperature curve that indicates a temperature change of an appliance over time and that is a target; a processor structured to convert the received target temperature curve into a block sequence in which blocks defined in a functional unit executable by the appliance are arranged in an order of operation; and an outputter structured to output the converted block sequence. The processor creates the block sequence while changing arrangement of the blocks and at least one of parameters of the blocks, acquires, as an estimated temperature curve, a temperature curve in a case where the appliance is caused to execute the created block sequence, and searches for the block sequence in which the estimated temperature curve approaches the target temperature curve.

The present disclosure has been described above based on the embodiments. It is to be understood by a person skilled in the art that the embodiments are examples, various modifications can be made to combinations of the respective components or the respective processing processes, and such modifications are also within the scope of the present disclosure.

In the present embodiment, the information processor 418 is included in the user apparatus 400. However, the present disclosure is not limited thereto, and for example, the information processor 418 may be connected to the network 300 as the information processing apparatus. At that time, the user apparatus 400 transmits the target temperature curve 700 and the additional information to the information processing apparatus via the network 300. The information processing apparatus converts the target temperature curve 700 into the functional block sequence 120 and transmits the functional block sequence 120 to the user apparatus 400. According to the present modification, the degree of freedom in the configuration can be improved.

In (3) creation of functional block sequences of the present embodiment, (iii) the processor 432 searches for the estimated temperature curve approaching the target temperature curve 700 according to Expression (1) and acquires the functional block sequence 120 corresponding to the estimated temperature curve detected. At that time, a check point may be provided at least one position of the target temperature curve 700, and whether or not the estimated temperature curve meets the check point may be visualized.

As described above, the estimated temperature curve is created by connecting the temperature curves for the plurality of functional blocks 110 included in the functional block sequence 120. The processor 432 specifies restriction conditions at a start timing, an end timing, and an intermediate timing on a per-temperature curve basis, that is, on a per-functional block 110 basis. The start timing refers to a timing at which the temperature curve starts, the end timing refers to a timing at which the temperature curve ends, and the intermediate timing refers to a timing at a point midway through the temperature curve, for example, a timing at the center of the temperature curve. In addition, the restriction conditions are defined within a certain range with respect to, for example, the temperature.

More specifically, the processor 432 acquires a temperature (hereinafter, referred to as a “first temperature”) at the start timing of one temperature curve, and acquires a temperature (hereinafter, referred to as a “second temperature”) of the target temperature curve 700 at the start timing. The processor 432 determines that the start timing of the one temperature curve satisfies the restriction conditions in a case where a difference between the first temperature and the second temperature is included in the certain range of the restriction conditions, and determines that the start timing of the one temperature curve does not satisfy the restriction conditions in a case where the difference between the first temperature and the second temperature is not included in the range described above. The processor 432 also executes such process at the intermediate timing and the end timing of the one temperature curve. In a case where the restriction conditions are satisfied at all of the start timing, the intermediate timing, and the end timing of the one temperature curve, the processor 432 determines that the one temperature curve satisfies the restriction conditions. Otherwise, the processor 432 determines that the one temperature curve does not satisfy the restriction conditions.

Further, the processor 432 performs a similar process on each of other temperature curves included in the estimated temperature curve. The processor 432 displays the estimated temperature curve on the display 410 by making the temperature curves satisfying the restriction conditions and the temperature curves satisfying no constraint condition in different colors. For example, the temperature curves that satisfy the restriction conditions are displayed in blue, and the temperature curves that do not satisfy the restriction conditions are displayed in red. At that time, the target temperature curve 700 may also be displayed on the display 410 as shown in FIG. 9. Further, the restriction conditions (temperature) themselves may be displayed on the display 410. According to the present modification, since whether or not the estimated temperature curve satisfies the check point is visualized, it is possible to notify the user of similarity between the estimated temperature curve and the target temperature curve 700.

What is claimed is:

1. An information processing method comprising:
receiving, as a target temperature curve, a temperature curve that indicates a temperature change of an appliance over time and that is a target;
converting the received target temperature curve into a block sequence in which blocks defined in a functional unit executable by the appliance are arranged in an order of operation; and
outputting the converted block sequence, wherein in the converting,
the block sequence is created while arrangement of the blocks and at least one of parameters of the blocks are changed,
a temperature curve in a case where the appliance is caused to execute the created block sequence is acquired as an estimated temperature curve, and
the block sequence in which the estimated temperature curve approaches the target temperature curve is searched for.

2. The information processing method according to claim 1, wherein the target temperature curve is created by handwriting of a user.

3. The information processing method according to claim 1, wherein in the receiving, additional information indicating a restriction in creating the block sequence is received together with the target temperature curve.

4. The information processing method according to claim 1, wherein in the receiving, additional information indicating correction content in acquiring the estimated temperature curve is received together with the target temperature curve.

5. The information processing method according to claim 1, wherein in the converting, the block sequence is determined in an order from the blocks on a front side to the blocks on a rear side of the block sequence in searching for the block sequence in which the estimated temperature curve approaches the target temperature curve.

6. The information processing method according to claim 1, further comprising
receiving modification of the temperature curve after converting the target temperature curve into the block sequence, wherein
in the converting, the temperature curve reflecting the modification is converted into the block sequence.

7. The information processing method according to claim 1, wherein in a case where it is determined that, in the converting, the received target temperature curve cannot be converted into the block sequence,
in the outputting, a notification that the conversion is impossible is made, or an alternative of the block sequence is output.

8. An information processing apparatus comprising:
a receiver structured to receive, as a target temperature curve, a temperature curve that indicates a temperature change of an appliance over time and that is a target;
a processor structured to convert the received target temperature curve into a block sequence in which blocks defined in a functional unit executable by the appliance are arranged in an order of operation; and
an outputter structured to output the converted block sequence, wherein
the processor
creates the block sequence while changing arrangement of the blocks and at least one of parameters of the blocks,
acquires, as an estimated temperature curve, a temperature curve in a case where the appliance is caused to execute the created block sequence, and
searches for the block sequence in which the estimated temperature curve approaches the target temperature curve.

9. A program causing a computer to:
receive, as a target temperature curve, a temperature curve that indicates a temperature change of an appliance over time and that is a target;
convert the received target temperature curve into a block sequence in which blocks defined in a functional unit executable by the appliance are arranged in an order of operation; and
output the converted block sequence, wherein in the converting,
the block sequence is created while arrangement of the blocks and at least one of parameters of the blocks are changed,
a temperature curve in a case where the appliance is caused to execute the created block sequence is acquired as an estimated temperature curve, and
the block sequence in which the estimated temperature curve approaches the target temperature curve is searched for.
